(19) United States
(12) Patent Application Publication
(10) Pub. No.: US 2017/0149131 A1
(43) Pub. Date: May 25, 2017

(54) ANTENNA CONTROL METHOD, ANTENNA CONTROL APPARATUS, AND ANTENNA DEVICE

(71) Applicant: Beijing Zhigu Rui Tuo Tech Co., Ltd., Beijing (CN)

(72) Inventor: Na Wei, Beijing (CN)

(21) Appl. No.: 15/284,591

(22) Filed: Oct. 4, 2016

(30) Foreign Application Priority Data
Nov. 20, 2015 (CN) 201510810118.5

(51) Int. Cl. H01Q 3/24; H01Q 1/24; H01Q 1/36

(52) U.S. Cl. CPC H01Q 3/24; H01Q 1/36; H01Q 1/24

(57) ABSTRACT

Embodiments of the present application provide an antenna control method, an antenna control apparatus, and an antenna device. The antenna control method comprises: determining a target pattern of multiple antennas according to at least a target antenna feature, wherein each antenna of the multiple antennas is at least partially fixed on a flexible substrate; and controlling, according to at least the target pattern and an actual pattern of the multiple antennas, the flexible substrate to be deformed. The embodiments of the present application provide a solution to control an antenna pattern.

### TECHNICAL FIELD

Embodiments of the present application relate to the technical field of communications, and in particular, to an antenna control method, an antenna control apparatus, and an antenna device.

### BACKGROUND

An antenna is an important constituent part of a communications device, and is a converter that can convert an electrical signal into an electromagnetic wave, and can also convert an electromagnetic wave into an electrical signal. Directivity of a single antenna is limited, and to be suitable for applications in various scenarios, according to a certain requirement, feeding and spatial arrangement are performed on two or more single antennas that work at a same frequency, to form an antenna array, which is also referred to as an antenna system, wherein an antenna in the antenna array is also referred to as an array element.

A pattern of an existing antenna array is generally fixed, and correspondingly, when some features of a beam formed by an antenna array need to be adjusted, adjustment is generally implemented by adjusting a weight of each array element in the antenna array.

### SUMMARY

In view of this, an objective of embodiments of the present application is to provide a solution to control an antenna pattern.

To achieve the foregoing objective, according to a first aspect of the embodiments of the present application, an antenna control method is provided, comprising:

determining a target pattern of multiple antennas according to at least a target antenna feature, wherein each antenna of the multiple antennas is at least partially fixed on a flexible substrate; and controlling, according to at least the target pattern and an actual pattern of the multiple antennas, the flexible substrate to be deformed.

To achieve the foregoing objective, according to a second aspect of the embodiments of the present application, an antenna control apparatus is provided, comprising:

a determining module, configured to determine a target pattern of multiple antennas according to at least a target antenna feature, wherein each antenna of the multiple antennas is at least partially fixed on a flexible substrate; and

a first control module, configured to control, according to at least the target pattern and an actual pattern of the multiple antennas, the flexible substrate to be deformed.

To achieve the foregoing objective, according to a third aspect of the embodiments of the present application, an antenna device provided, comprising:

a flexible substrate, manufactured by using a deformation controllable flexible material;

multiple antennas, wherein each antenna of the multiple antennas is at least partially fixed on the flexible substrate; and

a controller, configured to control the flexible substrate to be deformed.

At least one technical solution in the foregoing multiple technical solutions has the following beneficial effects:

In the embodiments of the present application, a target pattern of multiple antennas is determined according to at least a target antenna feature, wherein each antenna of the multiple antennas is at least partially fixed on a flexible substrate; and the flexible substrate is controlled, according to at least the target pattern and an actual pattern of the multiple antennas, to be deformed; and a solution to control an antenna pattern is provided, and specifically, deformation of a flexible substrate carrying multiple antennas is controlled to change a pattern of the multiple antennas, to cause that the pattern of the multiple antennas can better meet a required antenna feature.

### BRIEF DESCRIPTION OF THE DRAWINGS

FIG. 1 is a schematic flowchart of an embodiment of an antenna control method according to the present application;

FIG. 2A to FIG. 2C are separately a schematic diagram of a target pattern of multiple antennas;

FIG. 3A is a schematic diagram of a pattern of multiple antennas in a scenario according to an embodiment;

FIG. 3B to FIG. 3D are separately a schematic gain diagram when the multiple antennas have a different spacing in the scenario shown in FIG. 3A;

FIG. 4A is a schematic diagram of a pattern of multiple antennas in another scenario according to an embodiment;

FIG. 4B is a schematic gain diagram of the multiple antennas in the scenario shown in FIG. 4A;

FIG. 5A is a side view of a pattern change of multiple antennas according to an embodiment;

FIG. 5B is a top view of another pattern change of multiple antennas according to an embodiment;

FIG. 6A is a schematic structural diagram of an embodiment of an antenna control apparatus according to the present application;

FIG. 6B to FIG. 6E are separately a schematic structural diagram of an implementation manner of the embodiment shown in FIG. 6A; and

FIG. 7 is a schematic structural diagram of an embodiment of an antenna device according to the present application.

### DETAILED DESCRIPTION

Specific implementation manners of the present application are further described in detail below with reference to the accompanying drawings and embodiments. The following embodiments are intended to describe the present invention but are not intended to limit the scope of the present invention.

FIG. 1 is a schematic flowchart of an embodiment of an antenna control method according to the present application. As shown in FIG. 1, this embodiment comprises:

110: Determine a target pattern of multiple antennas according to at least a target antenna feature, wherein each antenna of the multiple antennas is at least partially fixed on a flexible substrate.

For example, the antenna control apparatus in the antenna control apparatus embodiment provided in the present application or an antenna device in an antenna device embodiment provided in the present application serves as an executing body of this embodiment, and performs 110 and 120.

In this embodiment, the target antenna feature is a feature that the multiple antennas are expected to achieve. Specifically, the target antenna feature optionally comprises, but is not limited to, at least one of the following: a target working frequency and a target directional gain. Specifically, the target working frequency indicates a frequency at which the multiple antennas are expected to work; and the target directional gain indicates a gain that the multiple antennas are expected to achieve at each direction. It should be noted that, each antenna on the flexible substrate may have multiple target working frequency. Optionally, all the antennas are grouped into multiple groups according to the target working frequencies, and each group of multiple antennas have a same target working frequency, and further, the method in this embodiment may be applied to any group of multiple antennas.

In this embodiment, the target pattern of the multiple antennas is a pattern that the multiple antennas are expected to achieve. Specifically, the target pattern of the multiple antennas optionally comprises, but is not limited to, at least one of the following: a target arrangement shape of the multiple antennas, at least one target direction of the multiple antennas, at least one target location of the multiple antennas, and at least one target spacing of the multiple antennas.

Specifically, the target arrangement shape of the multiple antennas optionally comprises, but is not limited to, any one of the following: a straight line, a rectangle, a square, a ring, and a circle. A rectangle indicates that the multiple antennas are arranged in a manner of N*M, wherein N and M are two different natural numbers; a square indicates that the multiple antennas are arranged in a manner of L*L, wherein L is a natural number.

Specifically, a target direction of each antenna of the multiple antennas is optionally the same or different. Correspondingly, at least one target direction of the multiple antennas is optionally a target direction, and the target direction is a unified target direction of the multiple antennas, or at least one target direction of the multiple antennas optionally comprises a target direction of each antenna of the multiple antennas. It should be noted that, a direction of each antenna in this embodiment means a maximum radiation direction.

Specifically, the at least one target location of the multiple antennas is optionally a target location, and the target location is optionally a target central location of the multiple antennas, or the at least one target location of the multiple antennas optionally comprises a target location of each antenna of the multiple antennas. The target central location is optionally a geometrical center location, for example, for multiple antennas that are arranged at an equal spacing to form a ring, a central location of the multiple antennas is a circle center location of the ring.

Specifically, at least one target spacing of the multiple antennas generally indicates a distance between every two adjacent antennas in the multiple antennas. For example, for multiple antennas whose target arrangement shape is a straight line, the at least one target spacing is optionally a target spacing, which means that the multiple antennas are expected to be arranged at an equal spacing to form a straight line, or the at least one target spacing optionally comprises P-1 target spacings, wherein P is a quantity of antennas. For multiple antennas whose target arrangement shape is a rectangle, the at least one target spacing is optionally a target spacing, and the target spacing indicates both a line spacing and a column spacing, that is, the line spacing is equal to the column spacing, or the at least one target spacing comprises two target spacing, one indicates a line spacing and the other indicates a column spacing. For multiple antennas whose arrangement shape is a ring, the at least one target spacing is optionally a target spacing, which means that the multiple antennas are expected to be arranged at an equal spacing to form a ring.

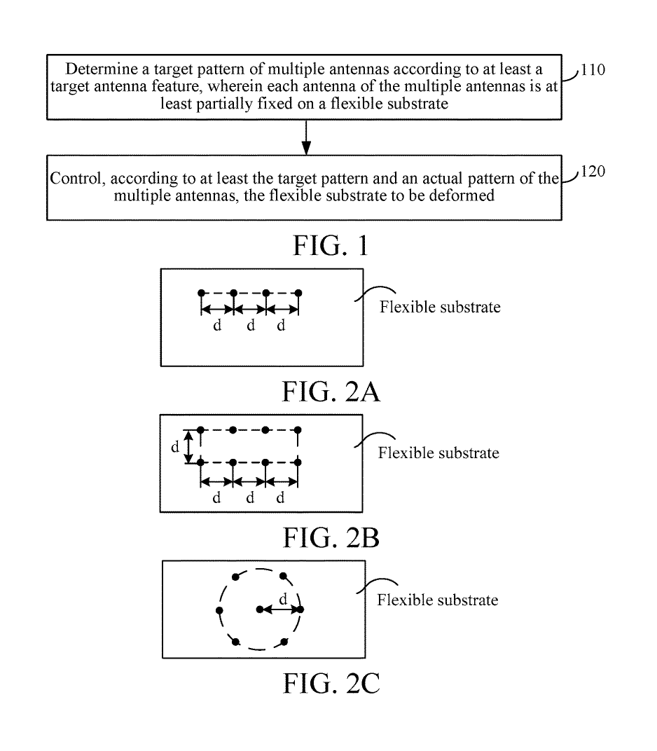

FIG. 2A to FIG. 2C are separately a schematic diagram of a target pattern of multiple antennas. As shown in FIG. 2A, four antennas (shown by solid dots in the figure) are arranged at an equal spacing on a flexible substrate to form a straight line, and a target spacing d is a distance between every two adjacent antennas. As shown in FIG. 2B, eight antennas (shown by solid dots in the figure) are arranged on a flexible substrate to form a 2*4 rectangle, and a target spacing d is both a line spacing and a column spacing. As shown in FIG. 2C, seven antennas (shown by solid dots in the figure) are arranged on a flexible substrate to form a circle, wherein one antenna is located at a circle center, and the other six antennas are arranged at an equal spacing in a circumference of the circle, and a target spacing d is a radius of the circle.

In this embodiment, the flexible substrate is manufactured by using a deformation controllable flexible material. Specifically, the flexible material optionally comprises, but is not limited to, any one of the following: an electroactive polymers (EAP) material, a memory metal material (also referred to as shape memory alloy), and an inverse piezoelectric material.

In this embodiment, each antenna of the multiple antennas may be at least partially fixed on the flexible substrate in multiple manners, which comprise, but are not limited to, an embedding manner and an attaching manner. For example, a prismatic antenna may be at least partially fixed on the flexible substrate in a manner of embedding the tail end into the flexible substrate, and a sheet-like antenna may be at least partially fixed on the flexible substrate in a manner of attaching one surface to the flexible substrate.

120: Control, according to at least the target pattern and an actual pattern of the multiple antennas, the flexible substrate to be deformed.

In this embodiment, the actual pattern of the multiple antennas means a pattern of the multiple antennas before the executing body of this embodiment performs 120, and is optionally obtained through detection. Similar to the target pattern, the actual pattern of the multiple antennas optionally comprises, but is not limited to, at least one of the following: an actual arrangement shape of the multiple antennas, at least one actual direction of the multiple antennas, at least one actual location of the multiple antennas, and at least one actual spacing of the multiple antennas. Specifically, definition of the actual arrangement shape, the at least one actual direction, the at least one actual location, and the at least one actual spacing are respectively similar to that of the target arrangement shape, the at least one target direction, the at least one target location, and the at least one target spacing in the target pattern, for example, the actual arrangement shape also optionally comprises, but is not limited to, any one of the following: a straight line, a rectangle, a square, a ring, and a circle.

In this embodiment, the target pattern is different from the actual pattern, that is, the target pattern and the actual pattern at least has one different pattern factor, for example, the target arrangement shape is different from the actual arrangement shape, or the at least one target spacing is different from the at least one actual spacing, or the at least one target direction is different from the at least one actual direction. Further, an objective of controlling the flexible substrate to be deformed is to change a pattern of the multiple antennas from the actual pattern to the target pattern. It should be noted that, a pattern of the multiple antennas after 120 may not completely achieve the target pattern, but should be closer to the target pattern than the actual pattern. It should be noted that, to make it easier to change the multiple antennas from the actual pattern to the target pattern, in 110, when the target pattern is determined, optionally, the actual pattern is further considered, that is, 110 comprises: determining the target pattern of the multiple antennas according to at least the target antenna feature and the actual pattern of multiple antennas.

In this embodiment, the flexible substrate is controlled to be deformed in multiple manners, which at least partially depend on a material for manufacturing the flexible substrate. For example, if the flexible substrate is manufactured by using an EAP material, optionally, an electrical field is applied to control the flexible substrate to be deformed; if the flexible substrate is manufactured by using a memory metal material, optionally, the flexible substrate is controlled to be deformed by means of a temperature, and further, the temperature may be controlled by controlling a current that flows through the flexible substrate; if the flexible substrate is manufactured by using an inverse piezoelectric material, optionally, an electrical field is applied to control the flexible substrate to be deformed.

In this embodiment, a target pattern of multiple antennas is determined according to at least a target antenna feature, wherein each antenna of the multiple antennas is at least partially fixed on a flexible substrate; and the flexible substrate is controlled, according to at least the target pattern and an actual pattern of the multiple antennas, to be deformed; and a solution to control an antenna pattern is provided, and specifically, deformation of a flexible substrate carrying multiple antennas is controlled to change a pattern of the multiple antennas, to cause that the pattern of the multiple antennas can better meet a required antenna feature.

The method in this embodiment is further described below by using some optional implementation manners.

In this embodiment, 110 may have multiple implementation manners.

In an optional implementation manner, the determining a target pattern of multiple antennas according to at least a target antenna feature comprises:

determining at least one target spacing of the multiple antennas according to at least the target working frequency.

Further, in different target arrangement shapes, a relationship between the at least one target spacing and the target working frequency may be different. The target arrangement shape may be the same as or may be different from the actual arrangement shape.

For example, for multiple antennas whose target arrangement shape is a straight line, a rectangle, or a square, to make it easier to adjust a direction of a beam formed by the multiple antennas, optionally, the at least one target spacing is set to ½ of a wavelength of a signal whose frequency is the target working frequency, that is, the multiple antennas are arranged at an equal spacing with a spacing being ½ of the wavelength to form a straight line, or the multiple antennas are arranged with ½ of the wavelength being a line spacing and a column spacing to form a rectangle or a square. In a possible scenario, the target working frequency is 2.45 gigahertz (GHz), and because a wavelength of a signal whose frequency is 2.45 GHz is about 4.8 inches, that is, is approximately equal to 12 centimeters, correspondingly, it is determined that the at least one target spacing is 6 centimeters. In another possible scenario, the target working frequency is 5.775 GHz, and because a wavelength of a signal whose frequency is 5.775 GHz is about 2 inches, that is, is approximately equal to 5 centimeters, correspondingly, it is determined that the at least one target spacing is 2.5 centimeters.

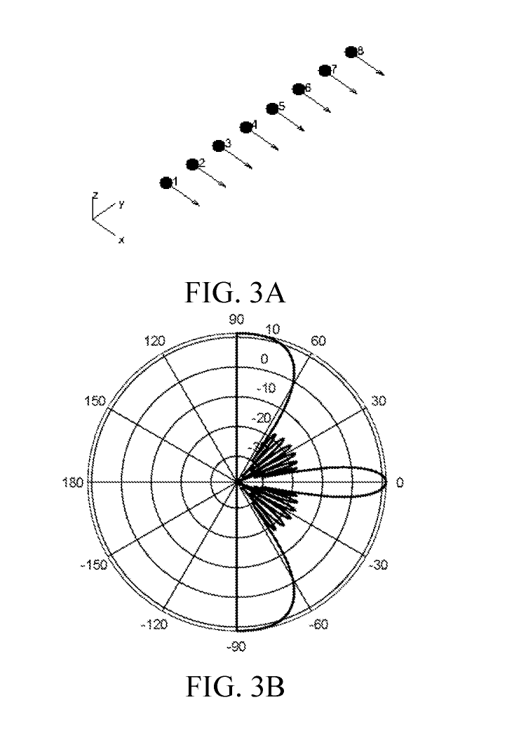

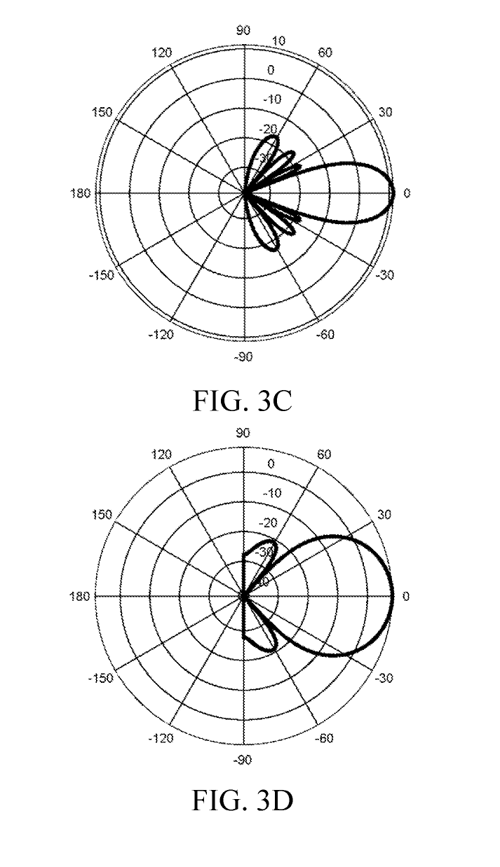

FIG. 3A is a schematic diagram of a pattern of multiple antennas in a scenario according to an embodiment. FIG. 3B to FIG. 3D are separately a schematic gain diagram when the multiple antennas have a different spacing in the scenario shown in FIG. 3A. In the scenario shown in FIG. 3A, eight antennas, as shown by dots 1 to 8, are arranged at an equal spacing to form a straight line, directions of the eight antennas all face a direction of the x-axis, working frequencies of the eight antennas are all 300 megahertz (MHz), weights of the eight antennas are the same, an amplitude and a phase of a signal are not offset, and a wavelength of the signal is denoted as λ. FIG. 3B is a schematic gain diagram when a spacing is equal to λ, FIG. 3C is a schematic gain diagram when a spacing is equal to λ/2, and FIG. 3D is a schematic gain diagram when a spacing is equal to λ/4. It should be noted that, each of FIG. 3B to FIG. 3D is a schematic diagram of a gain of the multiple antennas in a plane of the x-axis and the y-axis shown in FIG. 3A, wherein a location corresponding to a circle center is a central location of the multiple antennas, directions of 0 degrees, 30 degrees, 90 degrees, 120 degrees, 150 degrees, 180 degrees, −150 degrees, −120 degrees, −90 degrees, −60 degrees, −30 degrees are separately marked in a circumference, a direction corresponding to 0 degrees is the direction of the x-axis, each circle indicates a gain value, and in FIG. 3B to FIG. 3C, five circles successively outward from the innermost circle respectively indicate gain values −30 dBi, −20 dBi, −10 dBi, 0 dBi, and 10 dBi, and in FIG. 3D, five circles successively outward from the innermost circle respectively indicate gain values −40 dBi, −30 dBi, −20 dBi, −10 dBi, and 0 dBi. It can be known by comparing FIG. 3B to FIG. 3D that, when the spacing is λ/2, the gain is most centralized, and correspondingly, it may be easier to adjust, by adjusting the weights of the antennas, a direction of a beam formed by the eight antennas.

In another optional implementation manner, the determining a target pattern of multiple antennas according to at least a target antenna feature comprises:

determining at least one of the at least one target spacing of the multiple antennas, the at least one target direction of the multiple antennas, the at least one target location of the multiple antennas, and the target arrangement shape of the multiple antennas according to the at least the target directional gain.

It can be known from FIG. 3B to FIG. 3D that, when a spacing of the multiple antennas is different, gains of the multiple antennas are all different at many angles, that is, a directional gain of the multiple antennas is different.

In the gain diagrams shown in FIG. 3B to FIG. 3D, the direction corresponding to 0 degrees is the direction of the eight antennas, and correspondingly, when the direction of the eight antennas is changed, in the gain diagrams shown in FIG. 3B to FIG. 3D, the direction corresponding to 0 degrees is also changed, that is, the directional gain of the multiple antennas is also changed.

In the gain diagrams shown in FIG. 3B to FIG. 3D, the location corresponding to the circle center is the central location of the eight antennas, and correspondingly, when the location of the eight antennas is changed, in the gain diagrams shown in FIG. 3B to FIG. 3D, the location corresponding to the circle center is also changed, that is, the directional gain of the multiple antennas is also changed.

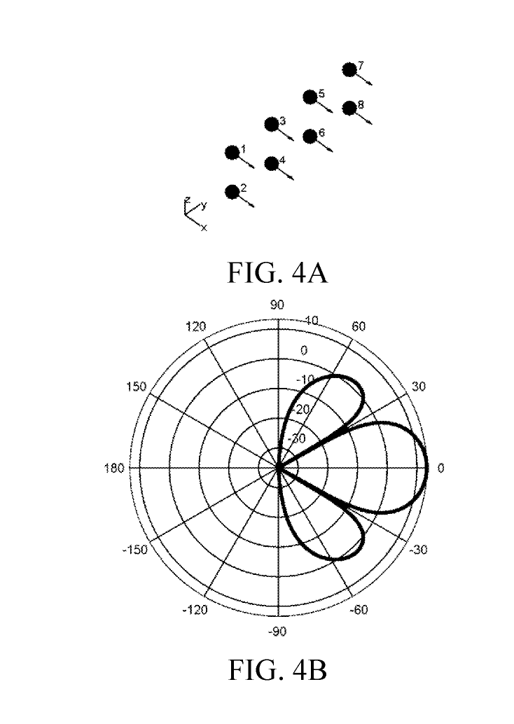

FIG. 4A is a schematic diagram of a pattern of multiple antennas in another scenario according to an embodiment. FIG. 4B is a schematic gain diagram of the multiple antennas in the scenario shown in FIG. 4A. In the scenario shown in FIG. 4A, eight antennas, as shown by dots 1 to 8 in the figure, are arranged in a manner of 4*2 to form a rectangle, directions of the eight antennas all face a direction of the x-axis, working frequencies of the eight antennas are all 300 MHz, weights of the eight antennas are the same, an amplitude and a phase of a signal are not offset, a wavelength of the signal is denoted as λ, and a line spacing and a column spacing of the rectangle are both λ/2. It should be noted that, FIG. 4B is a schematic diagram of a gain of the multiple antennas in a plane of the x-axis and the y-axis shown in FIG. 4A, wherein a location corresponding to a circle center is a central location of the multiple antennas, directions of 0 degrees, 30 degrees, 90 degrees, 120 degrees, 150 degrees, 180 degrees, −150 degrees, −120 degrees, −90 degrees, −60 degrees, and −30 degrees are separately marked in a circumference, a direction corresponding to 0 degrees is the direction of the x-axis, each circle indicates a gain value, five circles successively outward from the innermost circle respectively indicate gain values −30 dBi, −20 dBi, −10 dBi, 0 dBi, and 10 dBi. It can be known by comparing FIG. 3C and FIG. 4B that, when an arrangement shape of the eight antennas is changed, a directional gain of the eight antennas is also changed.

To sum up, the spacing, the direction, the location, and the arrangement shape of the multiple antennas all affect the directional gain of the multiple antennas, and correspondingly, at least one of the at least one target spacing of the multiple antennas, the at least one target direction of the multiple antennas, the at least one target location of the multiple antennas, and the target arrangement shape of the multiple antennas may be determined according to at least the target directional gain.

In this implementation manner, optionally, directional gains that can be separately achieved by the multiple antennas in multiple patterns are determined in a pre-learning manner, and a correspondence between a pattern of the multiple antennas and a directional gain is established. In 110, optionally, it is determined, according to the target directional gain and the correspondence, that the target pattern of the multiple antennas is a pattern corresponding to the target directional gain in the correspondence.

In this embodiment, 120 may have multiple implementation manners.

In an optional implementation manner, the controlling, according to at least the target pattern and an actual pattern of the multiple antennas, the flexible substrate to be deformed comprises:

determining at least one deformation parameter of the flexible substrate according to at least the target pattern and the actual pattern of the multiple antennas; and

controlling, according to at least the at least one deformation parameter, the flexible substrate to be deformed.

The at least one deformation parameter optionally indicates at least one area, on the flexible substrate, that is to be deformed, and a deformation manner of the at least one area.

In a possible scenario of this implementation manner, the at least one target direction in the target pattern of the multiple antennas is different from the at least one actual direction in the actual pattern of the multiple antennas. Optionally, the determining at least one deformation parameter of the flexible substrate according to at least the target pattern and the actual pattern of the multiple antennas comprises:

determining at least one longitudinal scaling parameter of the flexible substrate according to at least the at least one target direction and the at least one actual direction.

The at least one longitudinal scaling parameter optionally indicates at least one area, on the flexible substrate, that is to be scaled longitudinally, and a longitudinal scaling manner of the at least one area. Specifically, “longitudinal” refers to a direction perpendicular to a reference surface of the flexible substrate, and the reference surface is optionally a mounting plane of the flexible substrate. Correspondingly, the controlling, according to at least the at least one deformation parameter, the flexible substrate to be deformed is specifically: controlling, according to at least the at least one longitudinal scaling parameter, the flexible substrate to be scaled longitudinally.

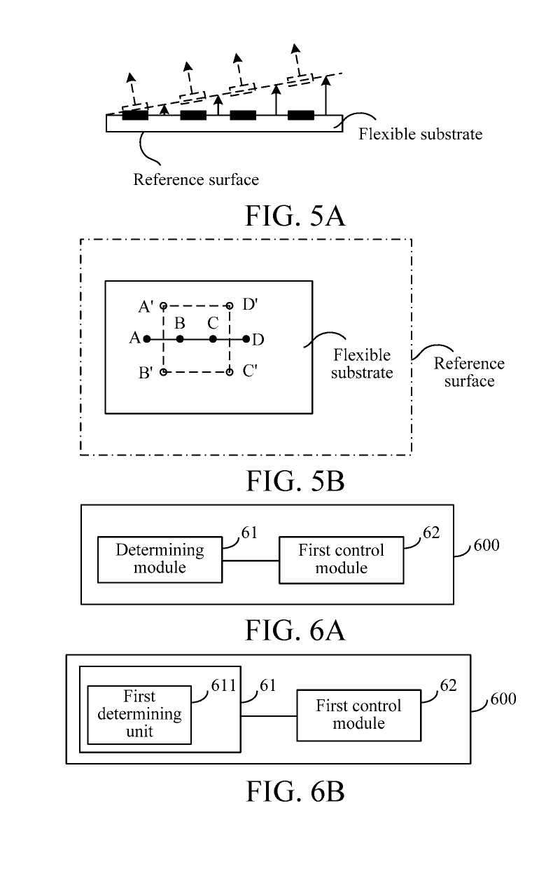

FIG. 5A is a side view of a pattern change of multiple antennas according to an embodiment. As shown in FIG. 5A, one surface of each antenna of four antennas (as shown by solid black boxes in the figure) is fixed on a side surface of a flexible substrate, and directions of the four antennas are all perpendicular to a reference surface of the flexible substrate, that is, actual directions of the four antennas are all perpendicular to the reference surface of the flexible substrate. In the target pattern determined in 110, target directions of the four antennas all need to form an angle of about 80 degrees with the reference surface. To change a pattern of the four antennas from an actual pattern to a target pattern, optionally, at least one area on the flexible substrate is controlled to be extended longitudinally, as shown by a solid arrow in the figure, and a side surface of the extended flexible substrate is lifted with a slope to a location indicated by a dashed line in the figure, and the four antennas correspondingly achieve a target pattern shown by the dashed boxes; in this case, the directions of the four antennas are shown by dashed arrows above the dashed boxes.

In another possible scenario of this implementation manner, the target arrangement shape in the target pattern of the multiple antennas is different from the actual arrangement shape in the actual pattern of the multiple antennas. Optionally, the determining at least one deformation parameter of the flexible substrate according to at least the target pattern and the actual pattern of the multiple antennas comprises:

determining at least one first horizontal scaling parameter of the flexible substrate according to at least the target arrangement shape and the actual arrangement shape.

The at least one first horizontal scaling parameter optionally indicates at least one area, on the flexible substrate, that is to be scaled horizontally, and a horizontal scaling manner of the at least one area. Specifically, “horizontal” refers to a direction parallel to the reference surface of the flexible substrate. Correspondingly, the controlling, according to at least the at least one deformation parameter, the flexible substrate to be deformed is specifically: controlling, according to at least the at least one first horizontal scaling parameter, the flexible substrate to be scaled horizontally.

FIG. 5B is a top view of another pattern change of multiple antennas according to an embodiment. As shown in FIG. 5B, four antennas (as shown by solid dots in the figure) are fixed on locations A, B, C and D on a flexible substrate. It can be known that, in an actual pattern of the four antennas, an actual arrangement shape of the four antennas is a straight line. In the target pattern determined in 110, a target arrangement shape of the four antennas is a square. To change a pattern of the four antennas from an actual pattern to a target pattern, optionally, at least one area on the flexible substrate is controlled to be extended or retracted horizontally, to cause the four antennas to respectively move from A, B, C, and D to A′, B′, C′, and D′, as shown by hollow dots in the figure.

In a possible scenario of this implementation manner, the at least one target location in the target pattern of the multiple antennas is different from the at least one actual location in the actual pattern of the multiple antennas. Optionally, the determining at least one deformation parameter of the flexible substrate according to at least the target pattern and the actual pattern of the multiple antennas comprises:

determining at least one second horizontal scaling parameter of the flexible substrate according to at least the at least one target location and the at least one actual location.

The at least one second horizontal scaling parameter optionally indicates at least one area, on the flexible substrate, that is to be scaled horizontally, and a horizontal scaling manner of the at least one area. Correspondingly, the controlling, according to at least the at least one deformation parameter, the flexible substrate to be deformed is specifically: controlling, according to at least the at least one second horizontal scaling parameter, the flexible substrate to be scaled horizontally.

In another possible scenario of this implementation manner, the at least one target spacing of the multiple antennas is different from the at least one actual spacing of the multiple antennas. Optionally, the determining at least one deformation parameter of the flexible substrate according to at least the target pattern and the actual pattern of the multiple antennas comprises:

determining at least one third horizontal scaling parameter of the flexible substrate according to at least the at least one target spacing and the at least one actual spacing.

The at least one third horizontal scaling parameter optionally indicates at least one area, on the flexible substrate, that is to be scaled horizontally, and a horizontal scaling manner of the at least one area. Correspondingly, the controlling, according to at least the at least one deformation parameter, the flexible substrate to be deformed is specifically: controlling, according to at least the at least one third horizontal scaling parameter, the flexible substrate to be scaled horizontally.

It should be noted that, in the foregoing scenarios, how to control the flexible substrate to be deformed is described separately by using an example in which the target pattern and the actual pattern only have one different pattern factor, and a person skilled in the art may understand that, when the target pattern and the actual pattern have multiple different pattern factors, the flexible substrate may be controlled to be deformed with reference to control manners in the foregoing scenarios.

In this embodiment, in addition to that deformation of the flexible substrate is controllable, optionally, deformation of at least one antenna in the multiple antennas is also controllable.

In an optional implementation manner, to provide more abundant antenna patterns, the target pattern of the multiple antennas further comprises: a target shape of the at least one antenna, and the actual pattern of the multiple antennas further comprises: an actual shape of the at least one antenna.

Optionally, this embodiment further comprises: controlling, according to at least the target shape of the at least one antenna and the actual shape of the at least one antenna, the at least one antenna to be deformed.

The at least one antenna is formed by a deformation controllable material, and optionally, the at least one antenna is formed by liquid metal.

The at least one antenna is the multiple antennas, that is deformation of each antenna of the multiple antennas is controllable, or the at least one antenna is some antennas of the multiple antennas, that is, deformation of only some antennas of the multiple antennas is controllable.

In a possible scenario of this implementation manner, a length of the at least one antenna is controllable; the target shape of the at least one antenna comprises: a target length of the at least one antenna; and the actual shape of the at least one antenna comprises: an actual length of the at least one antenna.

In this scenario, if the target length of the at least one antenna is different from the actual length of the at least one antenna, the controlling the at least one antenna to be deformed is specifically controlling a length of the at least one antenna to be changed.

In this scenario, optionally, the determining a target pattern of multiple antennas according to at least a target antenna feature comprises: determining the target length of the at least one antenna according to at least the target working frequency.

Generally, a length of an antenna is in direct proportion to a wavelength of a transmitted signal, that is, the target length of the at least one antenna is in inverse proportion to the target working frequency.

For example, when the target working frequency is 2.5 GHz, it is determined that the target length of the at least one antenna is 17 millimeters (mm); when the target working frequency is 0.96 GHz, it is determined that the target length of the at least one antenna is 55 mm.

In this scenario, each antenna is optionally formed by liquid metal. Specifically, liquid metal is filled in a straight pipe, when different voltages are applied to two ends of the straight pipe in a length direction, the liquid metal in the straight pipe is deformed to varying degrees to occupy space of different lengths in the straight pipe, and correspondingly, antennas formed by the liquid metal in the straight pipe have different lengths.

In another possible scenario of this implementation manner, a width of the at least one antenna is controllable; the target shape of the at least one antenna comprises: a target width of the at least one antenna; and the actual pattern of the at least one antenna comprises: an actual width of the at least one antenna.

In this scenario, optionally, when the target width of the at least one antenna is different from the actual width of the at least one antenna, the controlling the at least one antenna to be deformed is specifically controlling a width of the at least one antenna to be changed.

In this scenario, each antenna is optionally formed by liquid metal, and for a specific forming manner, reference may be made to a forming manner in the previous scenario.

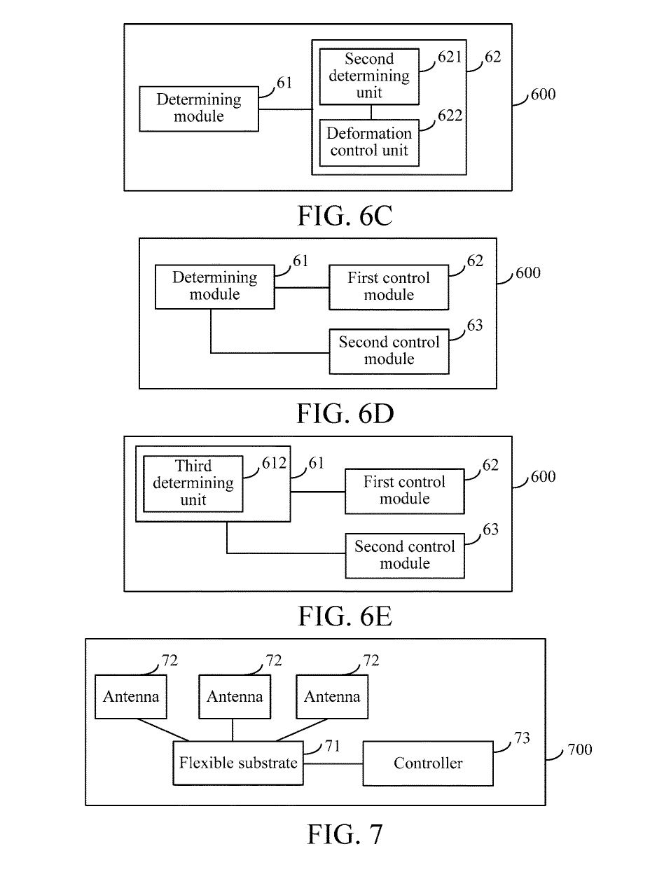

FIG. 6A is a schematic structural diagram of an embodiment of an antenna control apparatus according to the present application. As shown in FIG. 6A, the antenna control apparatus (apparatus for short below) 600 comprises:

a determining module 61, configured to determine a target pattern of multiple antennas according to at least a target antenna feature, wherein each antenna of the multiple antennas is at least partially fixed on a flexible substrate; and

a first control module 62, configured to control, according to at least the target pattern and an actual pattern of the multiple antennas, the flexible substrate to be deformed.

In this embodiment, the target antenna feature is a feature that the multiple antennas are expected to achieve. Specifically, the target antenna feature optionally comprises, but is not limited to, at least one of the following: a target working frequency and a target directional gain. Specifically, the target working frequency indicates a frequency at which the multiple antennas are expected to work; and the target directional gain indicates a gain that the multiple antennas are expected to achieve at each direction. It should be noted that, each antenna on the flexible substrate may have multiple target working frequency. Optionally, all the antennas are grouped into multiple groups according to the target working frequencies, and each group of multiple antennas have a same target working frequency, and further, each module in the apparatus 600 may perform a corresponding function on any group of multiple antennas.

In this embodiment, the target pattern of the multiple antennas is a pattern that the multiple antennas are expected to achieve. Specifically, the target pattern of the multiple antennas optionally comprises, but is not limited to, at least one of the following: a target arrangement shape of the multiple antennas, at least one target direction of the multiple antennas, at least one target location of the multiple antennas, and at least one target spacing of the multiple antennas.

Specifically, the target arrangement shape of the multiple antennas optionally comprises, but is not limited to, any one of the following: a straight line, a rectangle, a square, a ring, and a circle. A rectangle indicates that the multiple antennas are arranged in a manner of N*M, wherein N and M are two different natural numbers; a square indicates that the multiple antennas are arranged in a manner of L*L, wherein L is a natural number.

Specifically, a target direction of each antenna of the multiple antennas is optionally the same or different. Correspondingly, at least one target direction of the multiple antennas is optionally a target direction, and the target direction is a unified target direction of the multiple antennas, or at least one target direction of the multiple antennas optionally comprises a target direction of each antenna of the multiple antennas. It should be noted that, a direction of each antenna in this embodiment means a maximum radiation direction.

Specifically, the at least one target location of the multiple antennas is optionally a target location, and the target location is optionally a target central location of the multiple antennas, or the at least one target location of the multiple antennas optionally comprises a target location of each antenna of the multiple antennas. The target central location is optionally a geometrical center location, for example, for multiple antennas that are arranged at an equal spacing to form a ring, a central location of the multiple antennas is a circle center location of the ring.

Specifically, at least one target spacing of the multiple antennas generally indicates a distance between every two adjacent antennas in the multiple antennas. For example, for multiple antennas whose target arrangement shape is a straight line, the at least one target spacing is optionally a target spacing, which means that the multiple antennas are expected to be arranged at an equal spacing to form a straight line, or the at least one target spacing optionally comprises P-1 target spacings, wherein P is a quantity of antennas. For multiple antennas whose target arrangement shape is a rectangle, the at least one target spacing is optionally a target spacing, and the target spacing indicates both a line spacing and a column spacing, that is, the line spacing is equal to the column spacing, or the at least one target spacing comprises two target spacing, one indicates a line spacing and the other indicates a column spacing. For multiple antennas whose arrangement shape is a ring, the at least one target spacing is optionally a target spacing, which means that the multiple antennas are expected to be arranged at an equal spacing to form a ring.

FIG. 2A to FIG. 2C are separately a schematic diagram of a target pattern of multiple antennas. As shown in FIG. 2A, four antennas are arranged at an equal spacing to form a straight line, and a target spacing d is a distance between every two adjacent antennas. As shown in FIG. 2B, eight antennas are arranged to form a 2*4 rectangle, and a target spacing d is both a line spacing and a column spacing. As shown in FIG. 2C, seven antennas are arranged to form a circle, wherein one antenna is located at a circle center, and the other six antennas are arranged at an equal spacing in a circumference of the circle, and a target spacing d is a radius of the circle.

In this embodiment, the flexible substrate is manufactured by using a deformation controllable flexible material. Specifically, the flexible material comprises, but is not limited to, any one of the following: an EAP material, a memory metal material (also referred to as shape memory alloy), and an inverse piezoelectric material.

In this embodiment, each antenna of the multiple antennas may be at least partially fixed on the flexible substrate in multiple manners, which comprise, but are not limited to, an embedding manner and an attaching manner. For example, a prismatic antenna may be at least partially fixed on the flexible substrate in a manner of embedding the tail end into the flexible substrate, and a sheet-like antenna may be at least partially fixed on the flexible substrate in a manner of attaching one surface to the flexible substrate. In this embodiment, the actual pattern of the multiple antennas means a pattern of the multiple antennas before the first control module 62 controls the flexible substrate to be deformed, and is optionally obtained through detection. Similar to the target pattern, the actual pattern of the multiple antennas optionally comprises, but is not limited to, at least one of the following: an actual arrangement shape of the multiple antennas, at least one actual direction of the multiple antennas, at least one actual location of the multiple antennas, and at least one actual spacing of the multiple antennas. Specifically, definition of the actual arrangement shape, the at least one actual direction, the at least one actual location, and the at least one actual spacing are respectively similar to that of the target arrangement shape, the at least one target direction, the at least one target location, and the at least one target spacing in the target pattern, for example, the actual arrangement shape also optionally comprises, but is not limited to, any one of the following: a straight line, a rectangle, a square, a ring, and a circle.

In this embodiment, the target pattern is different from the actual pattern, that is, the target pattern and the actual pattern at least has one different pattern factor, for example, the target arrangement shape is different from the actual arrangement shape, or the at least one target spacing is different from the at least one actual spacing, or the at least one target direction is different from the at least one actual direction. Further, an objective of controlling, by the first control module 62, the flexible substrate to be deformed is to change a pattern of the multiple antennas from the actual pattern to the target pattern. It should be noted that, a pattern of the multiple antennas after the first control module 62 controls the flexible substrate to be deformed may not completely achieve the target pattern, but should be closer to the target pattern than the actual pattern. It should be noted that, to make it easier to change the multiple antennas from the actual pattern to the target pattern, when the determining module 61 determines the target pattern, optionally, the actual pattern is further considered, that is, the determining module 61 is specifically configured to determine the target pattern of the multiple antennas according to at least a target antenna feature and the actual pattern of multiple antennas.

In this embodiment, the first control module 62 controls the flexible substrate to be deformed in multiple manners, which at least partially depend on a material for manufacturing the flexible substrate. For example, if the flexible substrate is manufactured by using an EAP material, optionally, the first control module 62 applies an electrical field to control the flexible substrate to be deformed; if the flexible substrate is manufactured by using a memory metal material, optionally, the first control module 62 controls the flexible substrate to be deformed by means of a temperature, and further, the temperature may be controlled by controlling a current that flows through the flexible substrate; if the flexible substrate is manufactured by using an inverse piezoelectric material, optionally, the first control module 62 applies an electrical field to control the flexible substrate to be deformed.

In this embodiment, in the antenna control apparatus, the determining module determines a target pattern of multiple antennas according to at least a target antenna feature, wherein each antenna of the multiple antennas is at least partially fixed on a flexible substrate; and the first control module controls, according to at least the target pattern and an actual pattern of the multiple antennas, the flexible substrate to be deformed; and a solution to control an antenna pattern is provided, and specifically, deformation of a flexible substrate carrying multiple antennas is controlled to change a pattern of the multiple antennas, to cause that the pattern of the multiple antennas can better meet a required antenna feature.

The apparatus in this embodiment is further described below by using some optional implementation manners.

In this embodiment, the determining module 61 may have multiple implementation manners.

In an optional implementation manner, as shown in FIG. 6B, the determining module 61 comprises: a first determining unit 611, configured to determine at least one target spacing of the multiple antennas according to at least the target working frequency.

In another optional implementation manner, the determining module 61 comprises: a fourth determining unit, configured to determine at least one of the at least one target spacing of the multiple antennas, the at least one target direction of the multiple antennas, the at least one target location of the multiple antennas, and the target arrangement shape of the multiple antennas according to the at least the target directional gain.

In this embodiment, the first control module 62 may have multiple implementation manners.

In an optional implementation manner, as shown in FIG. 6C, the first control module 62 comprises:

a second determining unit 621, configured to determine at least one deformation parameter of the flexible substrate according to at least the target pattern and the actual pattern of the multiple antennas; and

a deformation control unit 622, configured to control, according to at least the at least one deformation parameter, the flexible substrate to be deformed.

In a possible scenario of this implementation manner, the at least one target direction in the target pattern of the multiple antennas is different from the at least one actual direction in the actual pattern of the multiple antennas. Optionally, the second determining unit 621 is specifically configured to determine at least one longitudinal scaling parameter of the flexible substrate according to at least the at least one target direction and the at least one actual direction. Correspondingly, the deformation control unit 622 is specifically configured to control, according to at least the at least one longitudinal scaling parameter, the flexible substrate to be scaled longitudinally.

In another possible scenario of this implementation manner, the target arrangement shape in the target pattern of the multiple antennas is different from the actual arrangement shape in the actual pattern of the multiple antennas. Optionally, the second determining unit 621 is specifically configured to determine at least one first horizontal scaling parameter of the flexible substrate according to at least the target arrangement shape and the actual arrangement shape. Correspondingly, the deformation control unit 622 is specifically configured to control, according to at least the at least one first horizontal scaling parameter, the flexible substrate to be scaled horizontally.

In a possible scenario of this implementation manner, the at least one target location in the target pattern of the multiple antennas is different from the at least one actual location in the actual pattern of the multiple antennas. Optionally, the second determining unit 621 is specifically configured to determine at least one second horizontal scaling parameter of the flexible substrate according to at least the at least one target location and the at least one actual location. Correspondingly, the deformation control unit 622 is specifically configured to control, according to at least the at least one second horizontal scaling parameter, the flexible substrate to be scaled horizontally.

In another possible scenario of this implementation manner, the at least one target spacing of the multiple antennas is different from the at least one actual spacing of the multiple antennas. Optionally, the second determining unit 621 is specifically configured to determine at least one third horizontal scaling parameter of the flexible substrate according to at least the at least one target spacing and the at least one actual spacing. Correspondingly, the deformation control unit 622 is specifically configured to control, according to at least the at least one third horizontal scaling parameter, the flexible substrate to be scaled horizontally.

It should be noted that, in the foregoing scenarios, how the first control module 62 controls the flexible substrate to be deformed is described separately by using an example in which the target pattern and the actual pattern only have one different pattern factor, and a person skilled in the art may understand that, when the target pattern and the actual pattern have multiple different pattern factors, the first control module 62 may control the flexible substrate to be deformed with reference to control manners in the foregoing scenarios.

In this embodiment, in addition to that deformation of the flexible substrate is controllable, optionally, deformation of at least one antenna in the multiple antennas is also controllable.

In an optional implementation manner, to provide more abundant antenna patterns, the target pattern of the multiple antennas further comprises: a target shape of the at least one antenna, and the actual pattern of the multiple antennas further comprises: an actual shape of the at least one antenna.

Optionally, as shown in FIG. 6D, the apparatus 600 further comprises: a second control module 63, configured to control, according to at least the target shape of the at least one antenna and the actual shape of the at least one antenna, the at least one antenna to be deformed.

The at least one antenna is formed by a deformation controllable material, and optionally, the at least one antenna is formed by liquid metal.

In a possible scenario of this implementation manner, a length of the at least one antenna is controllable; the target shape of the at least one antenna comprises: a target length of the at least one antenna; and the actual shape of the at least one antenna comprises: an actual length of the at least one antenna.

In this scenario, if the target length of the at least one antenna is different from the actual length of the at least one antenna, the controlling, by the second control module 63, the at least one antenna to be deformed is specifically controlling a length of the at least one antenna to be changed.

In this scenario, optionally, as shown in FIG. 6E, the determining module 61 comprises: a third determining unit 612, configured to determine the target length of the at least one antenna according to at least the target working frequency.

In another possible scenario of this implementation manner, a width of the at least one antenna is controllable; the target shape of the at least one antenna comprises: a target width of the at least one antenna; and the actual pattern of the at least one antenna comprises: an actual width of the at least one antenna.

In this scenario, optionally, when the target width of the at least one antenna is different from the actual width of the at least one antenna, the controlling, by the second control module 63, the at least one antenna to be deformed is specifically controlling a width of the at least one antenna to be changed.

For specific implementation of each implementation manner and each scenario in this embodiment, reference may be made to corresponding descriptions in the embodiment of the antenna control method provided in the present application.

FIG. 7 is a schematic structural diagram of an embodiment of an antenna device according to the present application. As shown in FIG. 7, the antenna device 700 comprises:

a flexible substrate 71, manufactured by using a deformation controllable flexible material;

multiple antennas 72, wherein each antenna 72 of the multiple antennas 72 is at least partially fixed on the flexible substrate 71; and

a controller 73, configured to control the flexible substrate 71 to be deformed.

In this embodiment, the antenna device 700 may be a device of any type that perform communication by using an antenna, and comprises, but is not limited to, any one of the following: an intelligent terminal, a wireless access point, and a base station.

Specifically, the flexible material for manufacturing the flexible substrate 71 optionally comprises, but is not limited to, any one of the following: an EAP material, a memory metal material (also referred to as shape memory alloy), and an inverse piezoelectric material.

In this embodiment, each antenna 72 of the multiple antennas 72 may be at least partially fixed on the flexible substrate 71 in multiple manners, which comprise, but are not limited to, an embedding manner and an attaching manner. For example, a prismatic antenna 72 may be at least partially fixed on the flexible substrate 71 in a manner of embedding the tail end into the flexible substrate 71, and a sheet-like antenna 72 may be at least partially fixed on the flexible substrate 71 in a manner of attaching one surface to the flexible substrate 71.

In this embodiment, an objective of controlling, by the controller 73, the flexible substrate 71 to be deformed generally is to change a pattern of the multiple antennas 72, and the pattern of the multiple antennas 72 affects an antenna feature of the multiple antennas 72.

In an optional implementation manner, the controller 73 is specifically configured to:

determine a target pattern of multiple antennas 72 according to at least a target antenna feature; and

control, according to at least the target pattern and an actual pattern of the multiple antennas 72, the flexible substrate 71 to be deformed.

For specific implementation of this implementation manner, reference may be made to corresponding descriptions in the embodiment of the antenna control method provided in the present application.

In another optional implementation manner, different from determining the target antenna feature in the previous implementation manner, in this implementation manner, an objective of controlling, by the controller 73, the flexible substrate 71 to be deformed is to determine an antenna feature that can be achieved by the multiple antennas 72 after the flexible substrate 71 is deformed.

In this embodiment, in addition to that deformation of the flexible substrate 71 is controllable, in an optional implementation manner, deformation of at least one antenna 72 of the multiple antennas 72 is controllable.

In this implementation manner, optionally, the controller 73 is further configured to control the at least one antenna 72 to be deformed.

The at least one antenna 72 is formed by a deformation controllable material, and optionally, the at least one antenna 72 is formed by liquid metal.

The at least one antenna 72 is the multiple antennas 72, that is, deformation of each antenna 72 of the multiple antennas 72 is controllable, or the at least one antenna 72 is some antennas 72 of the multiple antennas 72, that is, deformation of only some antennas 72 of the multiple antennas 72 is controllable.

For specific implementation of this implementation manner, reference may be made to corresponding descriptions in the embodiment of the antenna control method provided in the present application.

In an application scenario of this embodiment, the antenna device 700 is a mobile phone, and the mobile phone is designed to be capable of working in multiple frequency bands, for example, 1900 MHz of 3G and 2600 MHz of 4G. because frequency differences of these two frequency bands are great, in the prior art, two antenna arrays generally need to be set in the mobile phone to respectively match the two frequency bands, but after the solution in this embodiment is used, only one antenna array may be set in the mobile phone to match the two frequency bands. Using an example in which the antenna array is formed by two antennas 72, when the mobile phone needs to be switched from a 3G network to a 4G network, the controller 73 in the mobile phone controls, according to the target working frequency, that is, 2600 MHz, the flexible substrate 71 to be deformed to change a spacing between the two antennas 72, and controls the two antennas 72 to be deformed to change lengths of the two antenna 72, and the antenna array after the spacing and the lengths are changed is suitable for working at 2600 MHz; when the mobile phone needs to be switched from a 4G network to a 3G network, the controller 73 in the mobile phone controls, according to the target working frequency, that is, 1900 MHz, the flexible substrate 71 to be deformed to change a spacing between the two antennas 72, and controls the two antennas 72 to be deformed to change lengths of the two antennas 72, and the antenna array after the spacing and the lengths are changed is suitable for working at 1900 MHz.

A person of ordinary skill in the art may be aware that, in combination with the examples described in the embodiments disclosed in this specification, units and method steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

When the functions are implemented in the form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The computer software product is stored in a storage medium, and comprises several instructions for instructing a computer device (which may be a personal computer, a server, or a network device) to perform all or some of the steps of the methods described in the embodiments of the present invention. The storage medium comprises any medium that can store program code, such as a USB flash drive, a mobile hard disk, a read-only memory (ROM), a random access memory (RAM), a magnetic disk, or an optical disc.

The foregoing embodiments are merely intended for describing the present invention rather than limiting the present invention, and a person of ordinary skill in related technical field can make various changes and variations without departing from the spirit and scope of the present invention. Therefore, all equivalent technical solutions should also fall within the scope of the present invention, and the patent protection scope of the present invention shall be subject to the claims.

What is claimed is:

1. An antenna control method, wherein the method comprises:
determining a target pattern of multiple antennas according to at least a target antenna feature, wherein each antenna of the multiple antennas is at least partially fixed on a flexible substrate; and
controlling, according to at least the target pattern and an actual pattern of the multiple antennas, the flexible substrate to be deformed.

2. The method of claim 1, wherein the target antenna feature comprises at least one of the following: a target working frequency and a target directional gain.

3. The method of claim 2, wherein the target pattern of the multiple antennas comprises at least one of the following: at least one target direction of the multiple antennas, a target arrangement shape of the multiple antennas, at least one target location of the multiple antennas, and at least one target spacing of the multiple antennas; and the actual pattern of the multiple antennas comprises at least one of the following: at least one actual direction of the multiple antennas, an actual arrangement shape of the multiple antennas, at least one actual location of the multiple antennas, and at least one actual spacing of the multiple antennas.

4. The method of claim 3, wherein the target arrangement shape comprises any one of the following: a straight line, a rectangle, a square, a ring, and a circle; and the actual arrangement shape comprises any one of the following: a straight line, a rectangle, a square, a ring, and a circle.

5. The method of claim 3, wherein the determining a target pattern of multiple antennas according to at least a target antenna feature comprises: determining at least one target spacing of the multiple antennas according to at least the target working frequency.

6. The method of claim 3, wherein the controlling, according to at least the target pattern and an actual pattern of the multiple antennas, the flexible substrate to be deformed comprises:
determining at least one deformation parameter of the flexible substrate according to at least the target pattern and the actual pattern of the multiple antennas; and
controlling, according to at least the at least one deformation parameter, the flexible substrate to be deformed.

7. The method of claim 6, wherein the determining at least one deformation parameter of the flexible substrate according to at least the target pattern and the actual pattern of the multiple antennas comprises:
determining at least one longitudinal scaling parameter of the flexible substrate according to at least the at least one target direction and the at least one actual direction.

8. The method of claim 6, wherein the determining at least one deformation parameter of the flexible substrate according to at least the target pattern and the actual pattern of the multiple antennas comprises:
determining at least one first horizontal scaling parameter of the flexible substrate according to at least the target arrangement shape and the actual arrangement shape.

9. The method of claim 6, wherein the determining at least one deformation parameter of the flexible substrate according to at least the target pattern and the actual pattern of the multiple antennas comprises:
determining at least one second horizontal scaling parameter of the flexible substrate according to at least the at least one target location and the at least one actual location.

10. The method of claim 6, wherein the determining at least one deformation parameter of the flexible substrate according to at least the target pattern and the actual pattern of the multiple antennas comprises:
determining at least one third horizontal scaling parameter of the flexible substrate according to at least the at least one target spacing and the at least one actual spacing.

11. The method of claim 3, wherein deformation of at least one antenna in the multiple antennas is controllable; the target pattern of the multiple antennas further comprises: a target shape of the at least one antenna; and the actual pattern of the multiple antennas further comprises: an actual shape of the at least one antenna; and
the method further comprises: controlling, according to at least the target shape of the at least one antenna and the actual shape of the at least one antenna, the at least one antenna to be deformed.

12. The method of claim 11, wherein a length of the at least one antenna is controllable; the target shape of the at least one antenna comprises: a target length of the at least one antenna; and the actual shape of the at least one antenna comprises: an actual length of the at least one antenna.

13. The method of claim 12, wherein the determining a target pattern of multiple antennas according to at least a target antenna feature comprises: determining the target length of the at least one antenna according to at least the target working frequency.

14. The method claim 11, wherein the at least one antenna is formed by liquid metal.

15. The method of claim 1, wherein the flexible substrate is manufactured by using a deformation controllable flexible material.

16. An antenna control apparatus, wherein the apparatus comprises:
a determining module, configured to determine a target pattern of multiple antennas according to at least a target antenna feature, wherein each antenna of the multiple antennas is at least partially fixed on a flexible substrate; and
a first control module, configured to control, according to at least the target pattern and an actual pattern of the multiple antennas, the flexible substrate to be deformed.

17. The apparatus of claim 16, wherein the target antenna feature comprises at least one of the following: a target working frequency and a target directional gain.

18. The apparatus of claim 17, wherein the target pattern of the multiple antennas comprises at least one of the following: at least one target direction of the multiple antennas, a target arrangement shape of the multiple antennas, at least one target location of the multiple antennas, and at least one target spacing of the multiple antennas; and the actual pattern of the multiple antennas comprises at least one of the following: at least one actual direction of the multiple antennas, an actual arrangement shape of the multiple antennas, at least one actual location of the multiple antennas, and at least one actual spacing of the multiple antennas.

19. The apparatus of claim 18, wherein the target arrangement shape comprises any one of the following: a straight line, a rectangle, a square, a ring, and a circle; and the actual arrangement shape comprises any one of the following: a straight line, a rectangle, a square, a ring, and a circle.

20. The apparatus of claim 18, wherein the determining module comprises: a first determining unit, configured to determine at least one target spacing of the multiple antennas according to at least the target working frequency.

21. The apparatus of claim 18, wherein the first control module comprises:
a second determining unit, configured to determine at least one deformation parameter of the flexible substrate according to at least the target pattern and the actual pattern of the multiple antennas; and
a deformation control unit, configured to control, according to at least the at least one deformation parameter, the flexible substrate to be deformed.

22. The apparatus of claim 21, wherein the second determining unit is specifically configured to determine at least one longitudinal scaling parameter of the flexible substrate according to at least the at least one target direction and the at least one actual direction.

23. The apparatus of claim 21, wherein the second determining unit is specifically configured to determine at least one first horizontal scaling parameter of the flexible substrate according to at least the target arrangement shape and the actual arrangement shape.

24. The apparatus of claim 21, wherein the second determining unit is specifically configured to determine at least one second horizontal scaling parameter of the flexible substrate according to at least the at least one target location and the at least one actual location.

25. The apparatus of claim 21, wherein the second determining unit is specifically configured to determine at least one third horizontal scaling parameter of the flexible substrate according to at least the at least one target spacing and the at least one actual spacing.

26. The apparatus of claim 18, wherein deformation of at least one antenna in the multiple antennas is controllable; the target pattern of the multiple antennas further comprises: a target shape of the at least one antenna; and the actual pattern of the multiple antennas further comprises: an actual shape of the at least one antenna; and the apparatus further comprises: a second control module, configured to control, according to at least the target shape of the at least one antenna and the actual shape of the at least one antenna, the at least one antenna to be deformed.

27. The apparatus of claim 26, wherein a length of the at least one antenna is controllable; the target shape of the at least one antenna comprises: a target length of the at least one antenna; and the actual shape of the at least one antenna comprises: an actual length of the at least one antenna.

28. The apparatus of claim 27, wherein the determining module further comprises: a third determining unit, configured to determine the target length of the at least one antenna according to at least the target working frequency.

29. The apparatus of claim 26, wherein the at least one antenna is formed by liquid metal.

30. The apparatus of claim 16, wherein the flexible substrate is manufactured by using a deformation controllable flexible material.

31. An antenna device, wherein the antenna device comprises:
a flexible substrate, manufactured by using a deformation controllable flexible material;
multiple antennas, wherein each antenna of the multiple antennas is at least partially fixed on the flexible substrate; and
a controller, configured to control the flexible substrate to be deformed.

32. The antenna device of claim 31, wherein the controller is specifically configured to:
determine a target pattern of multiple antennas according to at least a target antenna feature; and
control, according to at least the target pattern and an actual pattern of the multiple antennas, the flexible substrate to be deformed.

33. The antenna device of claim 31, wherein deformation of at least one antenna in the multiple antennas is controllable.

34. The antenna device of claim 33, wherein the controller is further configured to control the at least one antenna to be deformed.

35. The antenna device of claim 33, wherein the at least one antenna is formed by liquid metal.
